(19) United States
(12) Patent Application Publication
(10) Pub. No.: US 2004/0167258 A1
(43) Pub. Date: Aug. 26, 2004

(54) Hot melt adhesive composition

(76) Inventors: Cecile Drogou, Heathfield Terrace (GB); Gwenaelle Allandrieu, Villeurbanne (FR); Justin A. Mehaffy, Hampton, NJ (US); Jagruti B. Patel, Branchburg, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/786,185

(22) Filed: Feb. 25, 2004

Related U.S. Application Data
(60) Provisional application No. 60/449,804, filed on Feb. 25, 2003.

(51) Int. Cl. C08K 5/01

(52) U.S. Cl. 524/270; 524/487

(57) ABSTRACT

A low application temperature comprising an ethylene n-butyl acrylate copolymer that can be applied at temperatures down to about 80° C. or less and is useful in case and carton sealing application.

This application claims priority to U.S. provisional Patent Application No. 60/449,804, filed Feb. 25, 2003.

### FIELD OF THE INVENTION

The invention relates to low application temperature hot melt adhesive compositions, specifically adhesives that can be applied at temperatures down to about 80° C. The adhesive finds use in packaging applications, in particular as case and carton sealing adhesives.

### BACKGROUND OF THE INVENTION

Hot melt adhesives are widely used for various commercial applications such as product assembly and packaging, including case sealing and carton closing operations. Such hot melt adhesives are applied to a substrate while in a molten state and cooled to harden the adhesive layer.

Most hot melt adhesives require temperatures of 350° F. (177° C.) or greater to ensure complete melting of all the components and also to achieve a satisfactory application viscosity. The need for such elevated temperatures is not without problems. The high temperatures increase operator risks with respect both to burns and to inhalation of residual volatiles. In addition, use of high temperatures requires more energy, placing greater demands on the manufacturing facility.

Although adhesive formulations that can be applied at temperatures below 300° F. (151° C.) can be prepared using low molecular weight components or a high wax content, application viscosity may suffer and there is a loss of adhesive properties, e.g., toughness, heat resistance and, often, specific adhesion to a substrate. While softer or more amorphous components may be added in order to improve adhesion, these components reduce the effective heat resistance.

While many improvements have been made in the development of low application temperature hot melt adhesive formulations, there continues to be a need for adhesives that can be applied at low temperatures and end uses that can benefits from the use of lower application temperatures. The current invention fulfills this need.

### SUMMARY OF THE INVENTION

The invention provides low application temperature hot melt adhesives, in particular hot melt adhesives that can be applied to a substrate at a temperature of less than about 110° C., preferably less than 100° C., more preferably less than about 90° C., and most preferably down to about 80° C. The adhesive comprises an ethylene copolymer, a paraffin wax, a rosin derived tackifier and an aromatic tackifier. In preferred embodiments, the adhesive is ethylene n-butyl acrylate based.

The invention also provides articles of manufacture comprising the adhesive. Articles encompassed by the invention include but are not limited to cartons, cases, trays and bags.

The invention further provides methods of sealing and/or forming a case, carton, tray or bag comprising applying the hot melt adhesive to seal and/or form the case, carton, tray, or bag.

The invention still further provides packaged articles, in particular frozen packaged articles. The packaged articles comprises a carton, case, tray or bag, wherein the carton, case, tray or bag is sealed with the adhesive.

The invention further provides a process for bonding a substrate to a similar or dissimilar substrate comprising applying to at least one substrate a molten hot melt adhesive composition, contacting the adhesive present on the substrate to a second substrate thereby bonding said substrates together, said hot melt adhesive comprising an ethylene copolymer, a paraffin wax, a rosin derived tackifier and an aromatic tackifier, wherein the adhesive is applied at a temperature of less than about 100° C., and may be applied at temperatures of from about 80° C. to about 90° C.

### DETAILED DESCRIPTION OF THE INVENTION

All documents cited herein are incorporated in their entireties by reference.

The invention is directed to a low application temperature adhesive, more specifically hot melt adhesives that can be applied at very low temperatures for e.g., case and carton sealing operations.

It has been discovered that certain hot melt adhesive formulations may advantageously be applied at temperatures below about 120° C., more typically below about 110° C., more preferably below about 100° C., even more preferable below about 90° C. and even more preferably below about 80° C. Application at these temperatures offer lower risk of burns, allow faster line speeds (lower application temperature means shorter open time), reduced heating costs, reduced amount of antioxidant needed, and outstanding pot shelf life.

Adhesives for use in the practice of the invention comprise an adhesive polymer, in particular an ethylene-based polymer, in combination with aromatic resins. The adhesive of the invention is particularly well-suited for use in automated assembly applications, such as but not limited to carton, case or tray formation where the adhesive is applied from large bulk industrial melting systems where assemblies speeds can reach hundreds of units per minute.

The adhesives of the invention will comprise at least one ethylene copolymer, and may comprise a blend of two or more polymers. The term ethylene copolymer, as used herein, refers to homopolymers, copolymers and terpolymers of ethylene. Preferred are copolymers of ethylene with one or more polar monomers, such as vinyl acetate or other vinyl esters of monocarboxylic acids, or acrylic or methacrylic acid or their esters with methanol, ethanol or other alcohols. Included are ethylene vinyl acetate, ethylene methyl acrylate, ethylene n-butyl acrylate, ethylene acrylic acid, ethylene methacrylate and mixtures and blends thereof. Preferred adhesives for use in the practice of the invention comprise at least one ethylene n-butyl acrylate copolymer. Mixtures of ethylene n-butyl acrylate and ethylene vinyl acetate are preferred. Particularly preferred embodiments will comprise only ethylene n-butyl acrylate as the ethylene copolymer.

Particularly preferred adhesives comprise an ethylene n-butyl acrylate copolymer containing up to about 45% by weight, typically 15 to 35% of n-butyl acrylate and has a melt index of at least about 900. Ethylene n-butyl acrylate copolymers are available from Elf Atochem North America, Philadelphia, Pa. under the tradename Lotryl®, from Exxon Chemical Co. under the tradename Enable® (e.g., EN33330 which has a melt index of about 330 grams/10 minutes and an n-butyl acrylate content of about 33% by weight in the copolymer and EN33900 which has a melt index of about 900 and an n-butyl acrylate content of about 35% by weight) and from Millennium Petrochemicals under the tradename Enathene® (e.g., EA 89822 which has a melt index of about 400 grams/10 minutes and a n-butyl acrylate content of about 35% by weight in the copolymer).

The polymer component will usually be present in an amount of from about 10 wt % to about 60 wt %, more preferably from about 20 wt % to about 40 wt %, even more preferably from about 25 wt % to about 35 wt %.

The adhesives will be formulated with a tackifier including aromatic tackifiers and a wax.

Useful tackifying resins may include any compatible resin or mixtures thereof such as natural and modified rosins including, for example, as gum rosin, wood rosin, tall oil rosin, distilled rosin, hydrogenated rosin, dimerized rosin, and polymerized rosin; glycerol and pentaerythritol esters of natural and modified rosins, including, for example as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; copolymers and terpolymers of natured terpenes, including, for example, styrene/terpene and alpha methyl styrene/terpene; polyterpene resins having a softening point, as determined by ASTM method E28-58T, of from about 80° C. to 150° C.; phenolic modified terpene resins and hydrogenated derivatives thereof including, for example, the resin product resulting from the condensation, in an acidic medium, of a bicyclic terpene and a phenol; aliphatic petroleum hydrocarbon resins having a Ball and Ring softening point of from about 70° C. to 135° C.; aromatic petroleum hydrocarbon resins and the hydrogenated derivatives thereof; and alicyclic petroleum hydrocarbon resins and the hydrogenated derivatives thereof. Mixtures of two or more of the above described tackifying resins may be required for some formulations. Also included are the cyclic or acyclic C₅ resins and aromatic modified acyclic or cyclic resins. Commercially available rosins that can be used to practice the invention include SYLVARES RE 115, available from Arizona Chemical and SYLVARES RE 104, available from Arizona Chemical.

The tackifier component will usually be present in an amount of from about 10 wt % to about 60 wt %, more preferably from about 20 wt % to about 40 wt %, even more preferably from about 25 wt % to about 35 wt %. Desirably up to about 35 weight % of the tackifier component will be an aromatic tackifier, typically from about 2 to about 25 wt %, more typically from about 5 to about 15 wt %. Preferred aromatic tackifiers are thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof. KRYSTALEX 3100 is a low molecular weight thermoplastic hydrocarbon polymer derived largely from alphamethylstryene which has a Ring and Ball softening point of 97 to 103° C. and is commercially available from Eastman.

Waxes suitable for use in the present invention include paraffin waxes, microcrystalline waxes, high density low molecular weight polyethylene waxes, by-product polyethylene waxes, Fischer-Tropsch waxes, oxidized Fischer-Tropsch waxes and functionalized waxes such as hydroxy stearamide waxes and fatty amide waxes. It is common in the art to use the terminology synthetic high melting point waxes to include high density low molecular weight polyethylene waxes, by-product polyethylene waxes and Fischer-Tropsch waxes. Modified waxes, such as vinyl acetate modified and maleic anhydride modified waxes may also be used.

Paraffin waxes that can be used in the practice of the invention include Okerin® 236 TP available from Astor Wax Corporation, Doraville, Ga.; Penreco® 4913 available from Pennzoil Products Co., Houston, Tex.; R-7152 Paraffin Wax available from Moore & Munger, Shelton, Conn.; and Paraffin Wax 1297 available from International Waxes, Ltd in Ontario, Canada, Pacemaker available from Citgo, and R-2540 available from Moore and Munger; and other paraffinic waxes such as those available from CP Hall under the product designations 1230, 1236, 1240, 1245, 1246, 1255, 1260, & 1262. CP Hall 1246 paraffinic wax is available from CP Hall (Stow, Ohio).

Wax will typically be present in the formulations of the invention in amounts of from about 10 to about 60 wt %.

The adhesives of the present invention may also contain a stabilizer or antioxidant. These compounds are added to protect the adhesive from degradation caused by reaction with oxygen induced by such things as heat, light, or residual catalyst from the raw materials such as the tackifying resin.

Among the applicable stabilizers or antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency, and correspondingly, its reactivity; this hindrance thus providing the phenolic compound with its stabilizing properties. Representative hindered phenols include; 1,3,5-trimethyl-2,4,6-tris-(3, 5-di-tert-butyl-4-hydroxybenzyl)-benzene; pentaerythrityl tetrakis-3(3, 5-di-tert-butyl-4-hydroxyphenyl)-propionate; n-octadecyl-3(3,5-di-tert-butyl-4-hydroxyphenyl)-propionate; 4,4′-methylenebis (2,6-tert-butyl-phenol); 4,4′-thiobis (6-tert-butyl-o-cresol); 2,6-di-tertbutylphenol; 6-(4-hydroxyphenoxy)-2,4-bis(n-octyl-thio)-1,3, 5 triazine; di-n-octylthio)ethyl 3,5-di-tert-butyl-4-hydroxy-benzoate; and sorbitol hexa[003-(3,5-di-tert-butyl-4-hydroxy-phenyl)-propionate].

The performance of these antioxidants may be further enhanced by utilizing, in conjunction therewith, known synergists such as, for example, thiodipropionate esters and phosphites. Distearylthiodipropionate is particularly useful. These stabilizers, if used, are generally present in amounts of about 0.1 to 1.5 weight percent, preferably 0.25 to 1.0 weight percent.

Such antioxidants are commercially available from Ciba-Geigy, Hawthorne, N.Y. and include Irganox® 565, 1010 and 1076 which are hindered phenols. These are primary antioxidants which act as radical scavengers and may be used alone or in combination with other antioxidants such as phosphite antioxidants like Irgafos® 168 available from Ciba-Geigy. Phosphite catalysts are considered secondary catalysts and are not generally used alone. These are primarily used as peroxide decomposers. Other available catalysts are Cyanox® LTDP available from Cytec Industries in Stamford, Conn., and Ethanox® 1330 available from Albemarle Corp. in Baton Rouge, La. Many such antioxidants are available either to be used alone or in combination with other such antioxidants. These compounds are added to the hot melts in small amounts and have no effect on other physical properties. Other compounds that could be added that also do not affect physical properties are pigments which add color, or fluorescing agents, to mention only a couple. Additives like these are known to those skilled in the art.

Depending on the contemplated end uses of the adhesives, other additives such as plasticizers, pigments and dyestuffs conventionally added to hot melt adhesives may be included. In addition, small amounts of additional tackifiers and/or waxes such as microcrystalline waxes, hydrogenated castor oil and vinyl acetate modified synthetic waxes may also be incorporated in minor amounts, i.e., up to about 10 weight percent by weight, into the formulations of the present invention.

The adhesive compositions of the present invention are prepared by blending the components in a melt until a homogeneous blend is obtained, usually about two hours is sufficient. Various methods of blending are known in the art and any method that produces a homogeneous blend is satisfactory.

The resulting adhesives are characterized by a viscosity at 100° C. of about 1150 cps and a viscosity at 80° C. of 2510 cps. They may be applied at low temperatures to provide superior adhesive bonds even when exposed to a wide variety of temperature conditions. The adhesives possess excellent cold resistance and are particularly useful in applications where high heat stress resistance performance is not crucial. E.g., in the packaging of temperature sensitive products such as chocolate, deep-freeze applications such as ice cream and ambient temperature applications.

The substrates to be bonded include virgin and recycled Kraft, high and low density Kraft, chipboard and various types of treated and coated Kraft and chipboard. Composite materials are also used for packaging applications such as for the packaging of alcoholic beverages. These composite materials may include chipboard laminated to an aluminum foil which is further laminated to film materials such as polyethylene, Mylar, polypropylene, polyvinylidene chloride, ethylene vinyl acetate and various other types of films. Additionally, these film materials also may be bonded directly to chipboard or Kraft. The aforementioned substrates by no means represent an exhaustive list, as a tremendous variety of substrates, especially composite materials, find utility in the packaging industry.

The following example is provided for purpose of illustration only. All parts are by weight and all temperatures in degrees Celsius unless otherwise noted.

### EXAMPLE

An adhesive formulation comprising 32.5% Enable EN 33900 (33% butyl acrylate, Ml 900), 32% Ter Hell 5603 (paraffinic wax having congealing point of 135° F.), 9.5% Kristalex F100 (pure monomer aromatic tackifier), 25.9% Sylvalite RE 88F (a rosin ester tackifier) and 0.1% Irganox 1010 (antioxidant) was prepared.

This adhesive formulation shows at 90° C. the same cold performance as a hot melt applied at 180° C. Application at such low temperatures offer lower risk of burns and other reduced safety concerns, allow faster line speeds (lower application temperature means shorter open time), reduced heating costs, cost savings on parts (e.g., hoses, nozzles) reduced amount of antioxidant needed, and outstanding pot shelf life.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A hot melt adhesive that can be applied to a substrate at a temperature of less than about 110° C., said adhesive comprising an ethylene copolymer, a paraffin wax, a rosin derived tackifier and an aromatic tackifier.

2. The adhesive of claim 1 that can be applied to a substrate at a temperature of from about 80° C. to a temperature of about 100° C.

3. The adhesive of claim 2 that can be applied to a substrate at a temperature of from about 80° C. to a temperature of about 90° C.

4. The adhesive of claim 1 wherein the adhesive polymer is ethylene n-butyl acrylate.

5. The adhesive of claim 4 comprising from about 20 to about 40 wt % of said ethylene n-butyl acrylate, from about 20 to about 40 wt % of said wax, from about 5 to about 30 wt % of an aromatic tackifier, and from about 2 to about 40 wt % a rosin tackifier.

6. An article of manufacture comprising the adhesive of claim 1.

7. The article of claim 6 which is a carton or carton, case, tray or bag.

8. A method of sealing and/or forming a case, carton, tray or bag comprising applying the hot melt adhesive of claim 1 to seal and/or form the case, carton, tray, or bag.

9. A packaged article contained within a carton, case, tray or bag, wherein the carton, case, tray or bag comprises the adhesive of claim 1.

10. The packaged article of claim 9 which is stored at temperature below about 0° C.

11. The packaged article of claim 12 which is a packaged food article.

12. A process for bonding a substrate to a similar or dissimilar substrate comprising applying to at least one substrate a molten hot melt adhesive composition and bonding said substrate together, said hot melt adhesive comprising the adhesive of claim 1, wherein the adhesive is applied at a temperature of less than about 100° C.

13. The process of claim 12 wherein the adhesive is applied at a temperature of about 80° C. to about 90° C.
